(19) United States
(12) Patent Application Publication
(10) Pub. No.: US 2013/0200298 A1
(43) Pub. Date: Aug. 8, 2013

(54) THERMAL CONDUCTIVE SHEET

(71) Applicant: Nitto Denko Corporation, Osaka (JP)

(72) Inventors: Seiji IZUTANI, Osaka (JP); Miho YAMAGUCHI, Osaka (JP); Keisuke HIRANO, Osaka (JP)

(73) Assignee: NITTO DENKO CORPORATION, Osaka (JP)

(21) Appl. No.: 13/760,265

(22) Filed: Feb. 6, 2013

(30) Foreign Application Priority Data
Feb. 8, 2012 (JP) 2012-025345

(51) Int. Cl. C09K 5/14

(52) U.S. Cl. CPC C09K 5/14
USPC 252/74

(57) ABSTRACT

A thermal conductive sheet contains boron nitride particles, an epoxy resin, and a curing agent. The epoxy resin contains a crystalline bisphenol epoxy resin and the curing agent contains a phenol resin having a partial structure represented by the following formula (1).

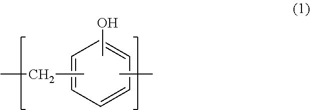

### CROSS-REFERENCE TO RELATED APPLICATION

The present application claims priority from Japanese Patent Application No. 2012-025345 filed on Feb. 8, 2012, the contents of which are hereby incorporated by reference into this application.

### BACKGROUND OF THE INVENTION

1. Field of the Invention

The present invention relates to a thermal conductive sheet, to be specific, to a thermal conductive sheet for use in power electronics technology.

2. Description of Related Art

In recent years, power electronics technology which uses semiconductor elements to convert and control electric power is applied in hybrid devices, high-brightness LED devices, and electromagnetic induction heating devices. In power electronics technology, a high current is converted to, for example, heat and therefore, materials that are disposed near the semiconductor element are required to have excellent heat dissipation properties (excellent thermal conductive properties).

For example, a thermosetting adhesive sheet made of an adhesive composition which contains a liquid epoxy resin, a curing agent component, a rubber component, and an inorganic filler has been proposed (ref: for example, Japanese Unexamined Patent Publication No. 2000-178517).

In order to obtain the thermosetting adhesive sheet in Japanese Unexamined Patent Publication No. 2000-178517, the adhesive composition is first prepared to be applied to a substrate film. Thereafter, the applied adhesive composition is heated so as to be brought into a semi-cured state to be formed into a sheet shape.

### SUMMARY OF THE INVENTION

However, the thermosetting adhesive sheet in Japanese Unexamined Patent Publication No. 2000-178517 has a low heat resistance and therefore, there is a disadvantage that, when used under high temperature conditions, the thermosetting adhesive sheet is deteriorated and various properties thereof including thermal conductive properties are reduced.

On the other hand, in the preparation of the adhesive composition in Japanese Unexamined Patent Publication No. 2000-178517, it has been tentatively proposed that the components, excluding the rubber component, are blended so as to improve the heat resistance. In such a case, there is a disadvantage that the epoxy resin is in a liquid state, so that it is difficult to form it into a sheet shape.

It is an object of the present invention to provide a thermal conductive sheet which has an excellent heat resistance, an excellent formability, and excellent thermal conductive properties.

A thermal conductive sheet of the present invention contains boron nitride particles, an epoxy resin, and a curing agent, wherein the epoxy resin contains a crystalline bisphenol epoxy resin and the curing agent contains a phenol resin having a partial structure represented by the following formula (1).

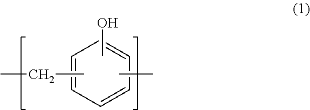

In the thermal conductive sheet of the present invention, it is preferable that the crystalline bisphenol resin is represented by the following formula (2).

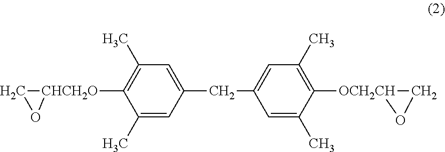

In the thermal conductive sheet of the present invention, it is preferable that the epoxy resin further contains a high molecular weight epoxy resin having a weight average molecular weight of 1000 or more.

In the thermal conductive sheet of the present invention, it is preferable that the phenol resin contains a phenol-aralkyl resin.

In the thermal conductive sheet of the present invention, it is preferable that the boron nitride particles are formed into a plate-like shape and the thermal conductivity in a direction perpendicular to the thickness direction of the thermal conductive sheet is 4 W/m·K or more.

The thermal conductive sheet of the present invention contains the epoxy resin and the curing agent; the epoxy resin contains the crystalline bisphenol resin; and the curing agent contains the phenol resin having a partial structure represented by the above-described formula (1), so that the thermal conductive sheet has an excellent formability and an excellent heat resistance. Therefore, the thermal conductive sheet can be surely formed into a sheet shape and be used under high temperature conditions.

The thermal conductive sheet of the present invention contains the boron nitride particles and the boron nitride particles have excellent thermal conductive properties, so that the thermal conductive properties of the thermal conductive sheet can be improved.

As a result, the thermal conductive sheet of the present invention can be used for various heat dissipation applications as a thermal conductive sheet having an excellent heat resistance, an excellent formability, and excellent thermal conductive properties.

### BRIEF DESCRIPTION OF THE DRAWINGS

FIG. 1 shows a perspective view of one embodiment of a thermal conductive sheet of the present invention.

FIG. 2 shows process drawings for illustrating a method for producing the thermal conductive sheet shown in FIG. 1:

(a) illustrating a step of hot pressing a thermal conductive composition or a laminated sheet,

(b) illustrating a step of dividing a pressed sheet into a plurality of pieces, and

(c) illustrating a step of laminating the divided sheets.

FIG. 3 shows a perspective view of a test device of Type I (before a bend test) in the bend test.

FIG. 4 shows a perspective view of a test device of Type I (during a bend test) in the bend test.

### DETAILED DESCRIPTION OF THE INVENTION

A thermal conductive sheet of the present invention contains boron nitride (BN) particles, an epoxy resin, and a curing agent (a hardener).

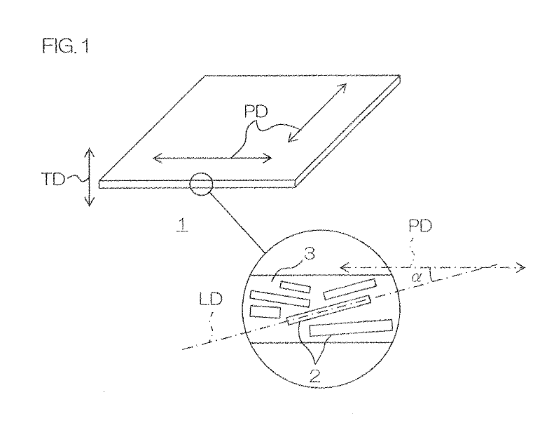

The boron nitride particles are formed into, for example, a plate-like shape (or a flake-like shape). The plate-like shape includes a hexagonal shape when viewed from the thickness direction of the plate. Also, the plate-like shape includes a linear shape (ref: FIG. 1) and furthermore, a shape having a portion that slightly bends halfway in its linear shape when viewed from a direction perpendicular to the thickness direction of the plate (the plane direction).

The average of the length in the longitudinal direction (the maximum length in a direction perpendicular to the thickness direction of the plate) of the boron nitride particles is, for example, 5 μm or more, preferably 10 μm or more, more preferably 20 μm or more, particularly preferably 30 μm or more, or most preferably 40 μm or more, and is usually, for example, 100 μm or less, or preferably 90 μm or less.

The average of the thickness (the length in the thickness direction of the plate, that is, the length in the short-side direction of the particles) of the boron nitride particles is, for example, 0.01 to 20 μm, or preferably 0.1 to 15 μm.

The aspect ratio (the length in the longitudinal direction/the thickness) of the boron nitride particles is, for example, 2 to 10000, or preferably 10 to 5000.

The average particle size of each of the boron nitride particles measured by a light scattering method is, for example, 5 μm or more, preferably 10 μm or more, more preferably 20 μm or more, particularly preferably 30 μm or more, or most preferably 40 μm or more, and is usually 100 μm or less.

The average particle size measured by the light scattering method is a volume average particle size measured with a dynamic light scattering type particle size distribution analyzer.

When the average particle size of each of the boron nitride particles measured by the light scattering method is below the above-described range, there may be a case where the thermal conductive sheet becomes fragile and the handling ability thereof is reduced.

The bulk density (JIS K 5101, the apparent density) of the boron nitride particles is, for example, 0.3 to 1.5 g/cm³, or preferably 0.5 to 1.0 g/cm³.

A commercially available product or processed goods thereof can be used as the boron nitride particles. Examples of the commercially available product of the boron nitride particles include the “PT” series (for example, “PT-110” or the like) manufactured by Momentive Performance Materials Inc., and the “SHOBN®UHP” series (for example, SHOBN®UHP-1″ or the like) manufactured by Showa Denko K.K.

The epoxy resin includes, for example, a crystalline bisphenol epoxy resin.

The crystalline bisphenol epoxy resin has a weight average molecular weight of, for example, below 1000, is in a solid state at normal temperature (at 25° C.), and has a symmetrical bisphenol structure.

To be specific, an example of the crystalline bisphenol epoxy resin includes a crystalline bisphenol F epoxy resin having a molecular structure that is symmetrical with respect to a methylene group.

The epoxy equivalent of the crystalline bisphenol epoxy resin is, for example, 100 to 500 g/eq., or preferably 150 to 400 g/eq.

The melting point of the crystalline bisphenol epoxy resin is, for example, 50 to 110° C., or preferably 60 to 100° C.

To be specific, an example of the crystalline bisphenol epoxy resin includes a bisphenol F glycidylether compound represented by the following formula (2).

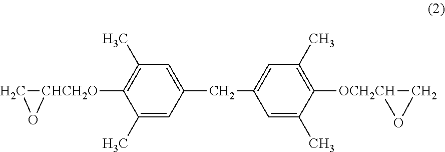

The bisphenol F glycidylether compound represented by the above-described formula (2) can show further higher crystallinity.

A commercially available product can be used as the crystalline bisphenol epoxy resin. To be specific, YSLV-80XY (manufactured by NIPPON STEEL CHEMICAL CO., LTD.) or the like is used.

The mixing ratio of the crystalline bisphenol epoxy resin with respect to the epoxy resin is, for example, 100 mass % or less, preferably 90 mass % or less, or more preferably 80 mass % or less, and is, for example, 10 mass % or more, or preferably 50 mass % or more.

Also, a high molecular weight epoxy resin can be contained in the epoxy resin as required.

The high molecular weight epoxy resin has a weight average molecular weight of 1000 or more and is in a state of liquid, semi-solid, or solid at normal temperature.

To be specific, examples of the high molecular weight epoxy resin include an aromatic epoxy resin such as a bisphenol epoxy resin, excluding the crystalline bisphenol epoxy resin, (for example, a bisphenol A epoxy resin, a bisphenol F epoxy resin, a bisphenol S epoxy resin, a hydrogenated bisphenol A epoxy resin, a dimer acid-modified bisphenol epoxy resin, and the like), a novolak epoxy resin (for example, a phenol novolak epoxy resin, a cresol novolak epoxy resin, a biphenyl epoxy resin, and the like), a naphthalene epoxy resin, a fluorene epoxy resin (for example, a bisaryl fluorene epoxy resin and the like), and a triphenylmethane epoxy resin (for example, a trishydroxyphenylmethane epoxy resin and the like); a nitrogen-containing-cyclic epoxy resin such as triepoxypropyl isocyanurate (triglycidyl isocyanurate) and a hydantoin epoxy resin; an aliphatic epoxy resin; an alicyclic epoxy resin (for example, a dicyclo ring-type epoxy resin and the like); and a glycidylamine epoxy resin.

Preferably, an aromatic epoxy resin is used, or more preferably, a bisphenol epoxy resin is used.

The weight average molecular weight of the high molecular weight epoxy resin is preferably 1000 to 100000.

Preferably, the high molecular weight epoxy resin is in a solid state at normal temperature. In such a case, the softening point (a ring and ball test) of the high molecular weight epoxy resin is, for example, 20 to 200° C., or preferably 35 to 150° C.

The epoxy equivalent of the high molecular weight epoxy resin is, for example, 100 to 100000 g/eq., or preferably 180 to 10000 g/eq.

These high molecular weight epoxy resins can be used alone or in combination of two or more.

By allowing the high molecular weight epoxy resin to be contained in the epoxy resin, the formability of the thermal conductive sheet can be further improved.

The mixing ratio of the high molecular weight epoxy resin with respect to 100 parts by mass of the crystalline bisphenol epoxy resin is, for example, 10 to 1000 parts by mass, or preferably 20 to 200 parts by mass.

The mixing ratio of the epoxy resin with respect to 100 parts by mass of the boron nitride particles is, for example, 10 parts by mass or more, or preferably 20 parts by mass or more, and is, for example, 200 parts by mass or less, or preferably 100 parts by mass or less.

When the mixing proportion of the epoxy resin is above the above-described range, the formability may be reduced. When the mixing proportion of the epoxy resin is below the above-described range, the thermal conductive properties may be reduced.

The curing agent is a latent curing agent (an epoxy resin curing agent) which is capable of curing the epoxy resin by heating. To be specific, an example of the curing agent includes a phenol resin having a partial structure represented by the following formula (1).

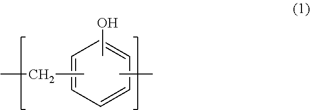

Examples of the phenol resin include a novolak phenol resin obtained by condensing phenol and formaldehyde under an acidic catalyst, and a phenol-aralkyl resin obtained by synthesizing phenol and dimethoxyparaxylene or bis(methoxymethyl)biphenyl.

The hydroxyl group equivalent of the phenol resin is, for example, 90 to 500 g/eq., or preferably 100 to 300 g/eq. The hydroxyl group equivalent is calculated by an acetyl chloride-potassium hydroxide titration method.

Preferably, in view of obtaining an advantage of toughening the epoxy resin after curing, a phenol-aralkyl resin is used.

To be specific, the phenol-aralkyl resin is represented by the following formula (3).

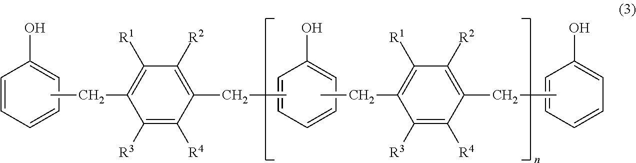

(R¹s to R⁴s are the same or different from each other and represent a hydrogen atom or a monovalent hydrocarbon group having 1 to 10 carbon atoms. “n” represents an integer of 0 to 10.)

An example of the monovalent hydrocarbon group represented by R¹ to R⁴ includes an alkyl group having 1 to 3 carbon atoms, such as methyl, ethyl, propyl, and isopropyl.

As R¹ to R⁴, preferably, a hydrogen atom is used.

A commercially available product can be used as the phenol-aralkyl resin. To be specific, MEH-7800-S, MEH-7800-SS (manufactured by MEIWA PLASTIC INDUSTRIES, LTD.), and the like are used.

These curing agents can be used alone or in combination of two or more.

The state of the curing agent is not particularly limited and the curing agent may be, for example, in a state of liquid, semi-solid, or solid at normal temperature. Preferably, the curing agent is in a solid state at normal temperature. In such a case, the softening point of the curing agent is, for example, 50 to 140° C. and the melting viscosity thereof at 150° C. is, for example, 0.01 to 3.0 Pa·s.

The mixing ratio of the curing agent is adjusted so that the ratio of the epoxy group equivalent to the phenolic hydroxyl group equivalent is, for example, 1.0/0.3 to 1.0/1.8, or preferably 1/0.5 to 1/1.5.

The curing agent can be used in combination with a curing accelerator.

Examples of the curing accelerator include an imidazole compound such as 2-phenyl imidazole, 2-methyl imidazole, 2-ethyl-4-methyl imidazole, and 2-phenyl-4-methyl-5-hydroxymethyl imidazole; a tertiary amine compound such as triethylenediamine and tri-2,4,6-dimethylaminomethylphenol; a phosphorus compound such as triphenylphosphine, tetraphenylphosphoniumtetraphenylborate, and tetra-n-butylphosphonium-o,o-diethylphosphorodithioate; a quaternary ammonium salt compound; an organic metal salt compound; and derivatives thereof.

As the curing accelerator, preferably, an imidazole compound is used.

These curing accelerators can be used alone or in combination of two or more.

The mixing ratio of the curing accelerator with respect to 100 parts by mass of the epoxy resin is, for example, 0.01 to 15 parts by mass, or preferably 0.1 to 10 parts by mass.

The curing accelerator can be prepared and used as required as a solution, that is, the curing accelerator dissolved in a solvent and/or as a dispersion liquid, that is, the curing accelerator dispersed in a solvent.

An example of the solvent includes an organic solvent such as ketone including acetone and methyl ethyl ketone, ester including ethyl acetate, and amide including N,N-dimethylformamide. An example of the solvent also includes an aqueous solvent such as water and an alcohol including methanol, ethanol, propanol, and isopropanol. As the solvent, preferably, an organic solvent is used, or more preferably, ketone is used.

Hereinafter, there may be a case where a composition which contains an epoxy resin, a curing agent, and a curing accelerator is referred to as an epoxy resin composition.

The above-described boron nitride particles and epoxy resin composition are blended to be stirred and mixed to prepare a thermal conductive composition and thereafter, the thermal conductive composition is formed into a sheet shape, so that the thermal conductive sheet of the present invention can be obtained.

An additive such as a dispersant and a thixotropic agent can be also blended in the thermal conductive composition.

The dispersant is blended in the thermal conductive composition as required so as to prevent aggregation or precipitation of the boron nitride particles to improve the dispersibility.

Examples of the dispersant include polyaminoamide salt and polyester.

These dispersants can be used alone or in combination. The mixing ratio of the dispersant with respect to 100 parts by mass of the total amount of the boron nitride particles and the epoxy resin composition is, for example, 0.1 to 20 parts by mass, or preferably 0.2 to 10 parts by mass.

The thixotropic agent is blended as required so as to improve the handling ability of the thermal conductive composition to improve the processability (the application properties and the like) thereof.

Examples of the thixotropic agent include a clay mineral, organic bentonite, carboxymethyl cellulose, sodium alginate, and aluminum stearate.

Preferably, a clay mineral is used, or to be specific, a phyllosilicate mineral (smectite, that is, a montmorillonite group mineral) having a layered structure is used. Examples of the montmorillonite group mineral include montmorillonite, magnesian montmorillonite, iron montmorillonite, iron magnesian montmorillonite, beidellite, aluminian beidellite, nontronite, aluminian nontronite, saponite, aluminian saponite, hectorite, sorconite, and stevensite.

A surface treatment may be applied to the surface of the clay mineral with a cationic dispersant and/or a nonionic dispersant.

These thixotropic agents can be used alone or in combination. The mixing ratio of the thixotropic agent with respect to 100 parts by mass of the total amount of the boron nitride particles and the epoxy resin composition is, for example, 0.1 to 20 parts by mass, or preferably 0.5 to 10 parts by mass.

The epoxy resin composition and the additive serve as a matrix (a dispersion medium) in which the boron nitride particles are dispersed.

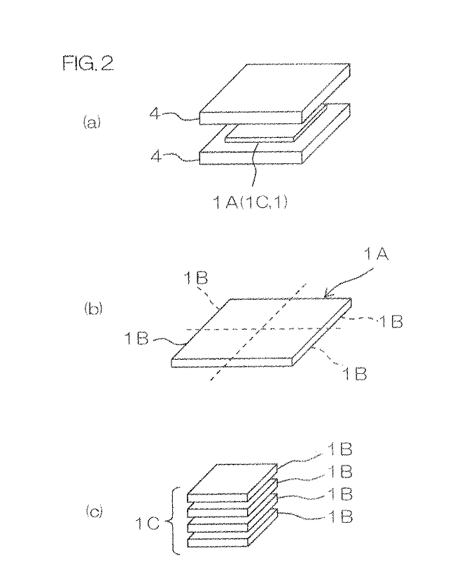

FIG. 1 shows a perspective view of one embodiment of a thermal conductive sheet of the present invention. FIG. 2 shows process drawings for illustrating a method for producing the thermal conductive sheet shown in FIG. 1.

Next, a method for producing one embodiment of the thermal conductive sheet of the present invention is described with reference to FIGS. 1 and 2. In this method, first, the boron nitride particles and the matrix (the epoxy resin composition and the additive) are blended at the above-described mixing proportion to be stirred and mixed, so that a thermal conductive composition is prepared.

In the stirring and mixing, in order to efficiently mix the components, for example, a solvent is blended with the boron nitride particles and the matrix.

An example of the solvent includes the same solvent as that described above. When the above-described curing agent and/or the curing accelerator are/is prepared as a solvent solution and/or a solvent dispersion liquid, the solvent of the solvent solution and/or the solvent dispersion liquid can also serve as a mixing solvent for the stirring and mixing without adding a solvent during the stirring and mixing. Or, in the stirring and mixing, a solvent can be further added as a mixing solvent.

The mixing ratio of the solvent with respect to 100 parts by mass of the total amount of the boron nitride particles and the matrix is, for example, 1 to 1000 parts by mass, or preferably 5 to 500 parts by mass.

In a case where the stirring and mixing is performed using a solvent, the solvent is removed after the stirring and mixing.

In order to remove the solvent, for example, the mixture is allowed to stand, for example, at room temperature for 1 to 48 hours; is heated, for example, at 40 to 100° C. for 0.5 to 3 hours; or is heated, for example, under a reduced pressure atmosphere of 0.001 to 50 kPa at 20 to 60° C. for 0.5 to 3 hours.

Next, in this method, the prepared thermal conductive composition is hot pressed.

To be specific, as shown in FIG. 2(a), for example, the thermal conductive composition is hot pressed with two releasing films 4 sandwiching the thermal conductive composition as required, so that a pressed sheet 1A is obtained. The conditions of the hot pressing are as follows: a temperature of, for example, 40 to 150° C., or preferably 50 to 140° C.; a pressure of, for example, 1 to 100 MPa, or preferably 5 to 50 MPa; and a duration of, for example, 0.1 to 100 minutes, or preferably 1 to 30 minutes.

More preferably, the thermal conductive composition is hot pressed under vacuum. The degree of vacuum in the vacuum hot pressing is, for example, 1 to 100 Pa, or preferably 5 to 50 Pa and the temperature, the pressure, and the duration are the same as those in the above-described hot pressing.

When the temperature, the pressure, and/or the duration in the hot pressing are outside of the above-described range, there may be a case where a porosity P (described later) of a thermal conductive sheet 1 cannot be adjusted to a desired value.

The thickness of the pressed sheet 1A obtained by the hot pressing is, for example, 50 to 1000 μm, or preferably 100 to 800 μm.

Next, in this method, as shown in FIG. 2(b), the pressed sheet 1A is divided into a plurality of pieces (for example, four pieces), so that divided sheets 1B are obtained (a dividing step). In the division of the pressed sheet 1A, the pressed sheet 1A is cut along the thickness direction thereof so that the pressed sheet 1A is divided into a plurality of pieces when projected in the thickness direction. The pressed sheet 1A is cut so that each of the divided sheets 1B has the same shape when the divided sheets 1B are projected in the thickness direction.

Next, in this method, as shown in FIG. 2(c), each of the divided sheets 1B is laminated in the thickness direction, so that a laminated sheet 1C is obtained (a laminating step).

Thereafter, in this method, as shown in FIG. 2(a), the laminated sheet 1C is hot pressed (preferably, hot pressed under vacuum) (a hot pressing step). The conditions of the hot pressing are the same as those in the hot pressing of the thermal conductive composition described above.

The thickness of the laminated sheet 1C after the hot pressing is, for example, 1 mm or less, or preferably 0.8 mm or less, and is usually, for example, 0.05 mm or more, or preferably 0.1 mm or more.

Thereafter, a series of the steps of the above-described dividing step (FIG. 2(b)), laminating step (FIG. 2(c)), and hot pressing step (FIG. 2(a)) are repeatedly performed so as to allow boron nitride particles 2 to be efficiently oriented in a plane direction PD in a matrix 3 in the thermal conductive sheet 1. The number of the repetition is not particularly limited and can be appropriately set in accordance with the dispersion state of the boron nitride particles. The number of the repetition is, for example, 1 to 10 times, or preferably 2 to 7 times.

In this way, the thermal conductive sheet 1 can be obtained.

The thermal conductive sheet 1 is obtained as a sheet in a semi-cured state (a B-stage state).

The thickness of the thermal conductive sheet 1 is, for example, 1 mm or less, or preferably 0.8 mm or less, and is usually, for example, 0.05 mm or more, or preferably 0.1 mm or more.

The content ratio of the boron nitride particles in the thermal conductive sheet 1 based on volume is, for example, 35 volume % or more, preferably 60 volume % or more, or more preferably 75 volume % or more, and is usually 95 volume % or less, or preferably 90 volume % or less.

When the content ratio of the boron nitride particles is below the above-described range, there may be a case where the boron nitride particles cannot be oriented in the plane direction (described later) in the thermal conductive sheet. When the content ratio of the boron nitride particles is above the above-described range, the formability of the thermal conductive sheet may be reduced.

In the thermal conductive sheet 1 obtained in this way, as shown in FIG. 1 and its partially enlarged schematic view, a longitudinal direction LD of the boron nitride particles 2 is oriented along the plane direction PD that crosses (is perpendicular to) a thickness direction TD of the thermal conductive sheet 1.

The calculated average of the angle (an orientation angle α of the boron nitride particles 2 with respect to the thermal conductive sheet 1) formed between the longitudinal direction LD of the boron nitride particles 2 and the plane direction PD of the thermal conductive sheet 1 is, for example, 25 degrees or less, or preferably 20 degrees or less, and is usually 0 degree or more.

The orientation angle α of the boron nitride particles 2 with respect to the thermal conductive sheet 1 is obtained as follows: the thermal conductive sheet 1 is cut along the thickness direction with a cross section polisher (CP); the cross section thus appeared is photographed with a scanning electron microscope (SEM) at a magnification that enables observation of 200 or more of the boron nitride particles 2 in the field view; a tilt angle α between the longitudinal direction LD of the boron nitride particles 2 and the plane direction PD (a direction perpendicular to the thickness direction TD) of the thermal conductive sheet 1 is obtained from the obtained SEM photograph; and the average value of the tilt angle α is calculated.

In this way, the thermal conductivity in the plane direction PD of the thermal conductive sheet 1 is, for example, 4 W/m·K or more, preferably 5 W/m·K or more, preferably 10 W/m·K or more, more preferably 15 W/m·K or more, or particularly preferably 25 W/m·K or more, and is usually 200 W/m·K or less.

The thermal conductivity in the plane direction PD of the thermal conductive sheet 1 is substantially the same before and after a thermal curing (a complete curing) to be described later.

When the thermal conductivity in the plane direction PD of the thermal conductive sheet 1 is below the above-described range, there may be a case where the thermal conductive properties in the plane direction PD is not sufficient, so that the thermal conductive sheet 1 cannot be used for heat dissipation applications that require the thermal conductive properties in the plane direction PD.

The thermal conductivity in the plane direction PD of the thermal conductive sheet 1 is measured by a pulse heating method. In the pulse heating method, a xenonflash analyzer “LFA-447” (manufactured by Erich NETZSCH GmbH & Co. Holding KG) is used.

The thermal conductivity in the thickness direction TD of the thermal conductive sheet 1 is, for example, 0.5 to 15 W/m·K, or preferably 1 to 10 W/m·K.

The thermal conductivity in the thickness direction TD of the thermal conductive sheet 1 is measured by a pulse heating method, a laser flash method, or a TWA method. In the pulse heating method, the above-described device is used; in the laser flash method, “TC-9000” (manufactured by Ulvac, Inc.) is used; and in the TWA method, “ai-Phase mobile” (manufactured by ai-Phase Co., Ltd.) is used.

In this way, the ratio (the thermal conductivity in the plane direction PD/the thermal conductivity in the thickness direction TD) of the thermal conductivity in the plane direction PD of the thermal conductive sheet 1 to the thermal conductivity in the thickness direction TD of the thermal conductive sheet 1 is, for example, 1.5 or more, preferably 3 or more, or more preferably 4 or more, and is usually 50 or less.

Although not shown in FIG. 1, for example, pores (gaps) are formed in the thermal conductive sheet 1.

The proportion of the pores in the thermal conductive sheet 1, that is, a porosity P, can be adjusted in accordance with the content ratio (based on volume) of the boron nitride particles 2 and furthermore, the temperature, the pressure, and/or the duration of the hot pressing (FIG. 2(a)) of the thermal conductive composition. To be specific, the porosity P can be adjusted by setting the temperature, the pressure, and/or the duration of the above-described hot pressing (FIG. 2(a)) within the above-described range.

The porosity P in the thermal conductive sheet 1 is, for example, 30 volume % or less, or preferably 10 volume % or less.

The above-described porosity P is measured as follows: for example, first, the thermal conductive sheet 1 is cut along the thickness direction with a cross section polisher (CP); the cross section thus appeared is observed with a scanning electron microscope (SEM) at a magnification of 200 to obtain an image; the obtained image is binarized based on the pore portion and the non-pore portion; and next, the area ratio of the pore portion with respect to the total area of the cross section of the thermal conductive sheet 1 is calculated.

In the measurement of the porosity P, the thermal conductive sheet 1 in a B-stage state is used.

When the porosity P of the thermal conductive sheet 1 is within the above-described range, the conformability to irregularities (described later) of the thermal conductive sheet 1 can be improved.

When the thermal conductive sheet 1 is evaluated in a bend test in conformity with the cylindrical mandrel method of JIS K 5600-5-1 under the following test conditions, for example, a fracture is not observed.

Test Conditions

Test Device: Type I

Mandrel: a diameter of 10 mm

Bending Angle: 90 degrees or more

Thickness of the thermal conductive sheet 1: 0.3 mm

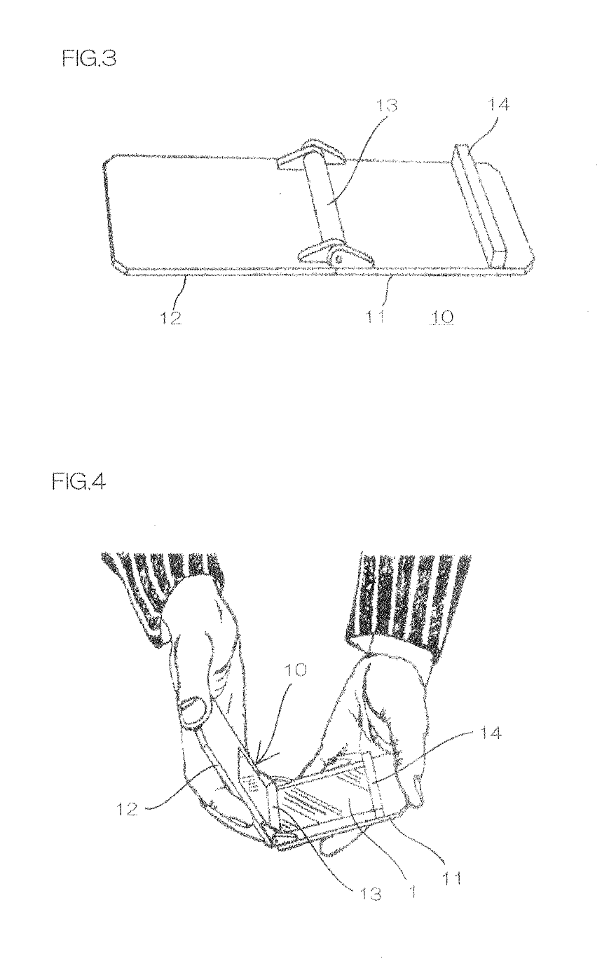

FIG. 3 shows a perspective view of a test device of Type I (before a bend test) in the bend test. FIG. 4 shows a perspective view of a test device of Type I (during a bend test) in the bend test.

The perspective views of the test device of Type I are shown in FIGS. 3 and 4. In the following, the test device of Type I is described.

In FIGS. 3 and 4, a test device 10 of Type I is provided with a first flat plate 11, a second flat plate 12 disposed in parallel with the first flat plate 11, and a mandrel (a rotation axis) 13 provided for allowing the first flat plate 11 and the second flat plate 12 to rotate relatively.

The first flat plate 11 is formed into a generally rectangular flat plate shape. A stopper 14 is provided at one end portion (a free end portion) of the first flat plate 11. The stopper 14 is formed on the surface of the first flat plate 11 so as to extend along the one end portion of the first flat plate 11.

The second flat plate 12 is formed into a generally rectangular flat plate shape. One side thereof is disposed so as to be adjacent to one side (one side of the other end portion (a proximal end portion) that is the opposite to the one end portion where the stopper 14 is provided) of the first flat plate 11.

The mandrel 13 is formed so as to extend along one side of the first flat plate 11 and the second flat plate 12 which are adjacent to each other.

shown in FIG. 3, in the test device 10 of Type I, the surface of the first flat plate 11 is flush with the surface of the second flat plate 12 before the start of the bend test.

In order to perform the bend test, the thermal conductive sheet 1 is placed on the surface of the first flat plate 11 and the surface of the second flat plate 12. The thermal conductive sheet 1 is placed so that one side thereof is brought into contact with the stopper 14.

Next, as shown in FIG. 4, the first flat plate 11 and the second flat plate 12 are rotated relatively. To be specific, the free end portion of the first flat plate 11 and the free end portion of the second flat plate 12 are rotated to a predetermined angle with the mandrel 13 as the center. To be more specific, the first flat plate 11 and the second flat plate 12 are rotated so as to bring the surfaces of the free end portions thereof closer (opposed to each other).

In this way, the thermal conductive sheet 1 conforms to the rotation of the first flat plate 11 and the second flat plate 12, and is bent with the mandrel 13 as the center.

Preferably, a fracture is not observed in the thermal conductive sheet 1 even when the bending angle is set to be 180 degrees under the above-described test conditions.

When a fracture is observed in the thermal conductive sheet 1 in the bend test at the above-described bending angle, there may be a case where an excellent flexibility cannot be imparted to the thermal conductive sheet 1.

In the bend test, the thermal conductive sheet 1 in a semi-cured state is used.

Furthermore, for example, when the thermal conductive sheet 1 is evaluated in a 3-point bending test in conformity with JIS K 7171 (in 2008) under the following test conditions, a fracture is not observed.

Test Conditions

Test piece: a size of 20 mm×15 mm

Distance between supporting points: 5 mm

Test rate: 20 mm/min (indenter depressing rate)

Bending angle: 120 degrees

Evaluation method: presence or absence of a fracture such as a crack at the central portion of the test piece is observed visually when tested under the above-described test conditions.

In the 3-point bending test, the thermally conductive sheet 1 in a semi-cured state is used.

Accordingly, the thermal conductive sheet 1 is excellent in the conformability to irregularities because a fracture is not observed in the above-described 3-point bending test. The conformability to irregularities is, when the thermal conductive sheet 1 is provided on an object to be provided with irregularities, the properties of the thermal conductive sheet 1 that conforms to be in close contact with the irregularities.

The thermal conductive sheet 1 does not fall off from, for example, an adherend in the following initial adhesion test. That is, a temporarily fixed state between the thermal conductive sheet 1 and the adherend is retained.

Initial adhesion test: The thermal conductive sheet 1 is thermocompression bonded onto the adherend along the horizontal direction to be temporarily fixed thereon to be allowed to stand for 10 minutes. Thereafter, the adherend is reversed upside-down.

Examples of the adherend include a substrate made of stainless steel (for example, SUS 304 and the like) or a mounting substrate for notebook PC on which a plurality of electronic components such as IC (integrated circuit) chips, condensers, coils, and resistors are mounted. In the mounting substrate for notebook PC, the electronic components are usually disposed at spaced intervals to each other on the upper surface (one surface) in the plane direction (the plane direction of the mounting substrate for notebook PC).

In the compression bonding, for example, a sponge roll made of a resin such as a silicone resin is pressed with respect to the thermal conductive sheet 1 at 80° C. and is rolled on the surface of the thermal conductive sheet 1.

In the above-described initial adhesion test, the thermal conductive sheet 1 in a B-stage state is used.

The thermal conductive sheet 1 is attached to an object to be dissipated which serves as the adherend and then, is thermally cured (brought into a C-stage state) by heating, so that the thermal conductive sheet 1 is adhered to the object to be dissipated.

In order to thermally cure the thermal conductive sheet 1, the thermal conductive sheet 1 is heated at, for example, 60 to 250° C., or preferably 80 to 200° C. for, for example, 5 to 300 minutes, or preferably 10 to 200 minutes.

The glass transition temperature of the thermal conductive sheet 1 in a C-stage state is, for example, 100° C. or more, preferably 110° C. or more, or more preferably 120° C. or more, and is, for example, 300° C. or less.

When the glass transition temperature is the above-described lower limit or more, an excellent heat resistance of the thermal conductive sheet 1 can be ensured, so that a deformation or a deterioration under high temperature can be reduced.

The glass transition temperature is obtained as a peak value of tan δ (loss tangent) that is determined by a dynamic viscoelasticity measurement using a frequency of 10 Hz.

The 5% mass loss temperature of the thermal conductive sheet 1 in a C-stage state is, for example, 250° C. or more, or preferably 300° C. or more, and is, for example, 450° C. or less.

When the 5% mass loss temperature is the above-described lower limit or more, decomposition can be suppressed even when exposed to high temperature and heat generated from various devices can be efficiently conducted.

The 5% mass loss temperature can be measured by thermogravimetric analysis (a temperature rising rate of 10° C./min, under a nitrogen atmosphere) in conformity with JIS K 7120.

The thermal conductive sheet 1 contains the epoxy resin and the curing agent; the epoxy resin contains the crystalline bisphenol resin; and the curing agent contains the phenol resin having a partial structure represented by the above-described formula (1), so that the thermal conductive sheet 1 has an excellent formability and an excellent heat resistance.

Therefore, the thermal conductive sheet 1 can be surely formed into a sheet shape and be used under high temperature conditions.

The thermal conductive sheet 1 contains the boron nitride particles 2 and the boron nitride particles 2 have excellent thermal conductive properties, so that the thermal conductive properties of the thermal conductive sheet 1 can be improved.

Among all, when the boron nitride particles 2 in a plate-like shape are oriented in the plane direction PD, the thermal conductive properties in the plane direction PD of the thermal conductive sheet 1 can be improved.

As a result, the thermal conductive sheet 1 can be used for various heat dissipation applications as a thermal conductive sheet having an excellent heat resistance, an excellent formability, and excellent thermal conductive properties in the plane direction PD.

To be specific, by covering an electronic element with the thermal conductive sheet 1, the electronic element can be protected and heat from the electronic element can be thermally conducted efficiently.

The electronic element to be covered with the thermal conductive sheet 1 is not particularly limited and examples thereof include IC (integrated circuit) chips, condensers, coils, resistors, and light emitting diodes. These electronic elements are usually provided on a substrate and are disposed at spaced intervals to each other in the plane direction (the plane direction of the substrate).

Among all, by covering electronic components used for power electronics and/or the mounting substrate on which the electronic components are mounted with the thermal conductive sheet 1, the deterioration of the thermal conductive sheet 1 due to heat can be prevented and the heat from the electronic components and/or the mounting substrate can be dissipated along the plane direction PD by the thermal conductive sheet 1.

Examples of the electronic components used for power electronics include IC (integrated circuit) chips (in particular, narrow width portions of electrode terminals in IC chips), thyristors (rectifiers), motor parts, inverters, electrical power transmission components, condensers, coils, resistors, and light emitting diodes.

The above-described electronic components are mounted on the surface (one surface) of the mounting substrate and on the mounting substrate, the electronic components are disposed at spaced intervals to each other in the plane direction (the plane direction of the mounting substrate).

The thermal conductive sheet 1 having an excellent heat resistance can be also provided on, for example, an LED heat dissipation substrate or a heat dissipation material for batteries.

In the above-described embodiment in FIG. 2(a), the thermal conductive composition is hot pressed, so that the pressed sheet 1A is obtained. Alternatively, for example, a sheet 1A can be fabricated by, for example, an extrusion molding or the like.

In such a case, the orientation of the longitudinal direction LD of the boron nitride particles 2 with respect to the plane direction PD of the thermal conductive sheet 1 can be disturbed. In that case, the thermal conductivity in the plane direction PD/the thermal conductivity in the thickness direction TD of the thermal conductive sheet 1 is, for example, 1 to 2, or preferably 1 to 1.5.

Preferably, the pressed sheet 1A is obtained by the hot pressing of the thermal conductive composition. In this way, the boron nitride particles 2 can be surely oriented along the plane direction PD in the thermal conductive sheet 1, so that the thermal conductive properties in the plane direction PD of the thermal conductive sheet 1 can be improved.

Alternatively, a varnish of the thermal conductive composition is prepared and thereafter, the prepared varnish is applied and dried, so that the sheet 1A can be fabricated.

The varnish of the thermal conductive composition is prepared as a liquid by blending the above-described components with the above-described solvent.

Thereafter, the varnish is applied to the surface of a substrate by, for example, a coating device such as an applicator, a roll coater, or the like to be subsequently dried. The drying conditions are as follows: heating at a temperature of, for example, 40 to 90° C., or preferably 50 to 85° C. and a duration of, for example, 0.1 to 60 minutes, or preferably 1 to 30 minutes. The drying can be also performed in multiple times.

In this way, the sheet 1A is obtained. Thereafter, a series of the steps of the dividing step (FIG. 2(b)), the laminating step (FIG. 2(c)), and the hot pressing step (FIG. 2(a)) are repeatedly performed so as to allow the boron nitride particles 2 to be efficiently oriented in the plane direction PD in the matrix 3 in the thermal conductive sheet 1, so that the thermal conductive sheet 1 is obtained.

The thermal conductive sheet 1 obtained by fabricating the sheet 1A by the application of the varnish achieves the same function and effect as that of the thermal conductive sheet 1 obtained by fabricating the pressed sheet 1A (FIG. 2(a)) by the hot pressing of the thermal conductive composition.

### EXAMPLE

While the present invention will be described hereinafter in further detail with reference to Examples and Comparative Examples, the present invention is not limited to these Examples and Comparative Examples.

### Examples 1 to 6

In conformity with the mixing formulation of Tables 1 and 2, boron nitride particles, an epoxy resin composition, and a solvent were blended to be stirred and the obtained mixture was allowed to stand at room temperature (at 23° C.) for one night. Thus, methyl ethyl ketone (the solvent) was allowed to volatilize, so that a thermal conductive composition in a solid state at normal temperature was prepared.

Next, the obtained thermal conductive composition was sandwiched by two releasing films which were subjected to a silicone treatment to be hot pressed with a vacuum hot press machine at 80° C. under an atmosphere (a vacuum atmosphere) of 10 Pa with a load of 5 tons (20 MPa) for two minutes, so that a pressed sheet having a thickness of 0.3 mm was obtained (ref: FIG. 2(a)).

Thereafter, the obtained pressed sheet was cut so as to be divided into a plurality of pieces when projected in the thickness direction of the pressed sheet, so that divided sheets were obtained (ref: FIG. 2(b)). Subsequently, the divided sheets were laminated in the thickness direction, so that a laminated sheet was obtained (ref: FIG. 2(c)).

Subsequently, the obtained laminated sheet was hot pressed under the same conditions as those described above with the same vacuum hot press machine as that described above (ref: FIG. 2(a)).

Next, a series of the above-described operations of cutting, laminating, and hot pressing (ref: FIG. 2) were repeated four times, so that a thermal conductive sheet in a B-stage state having a thickness of 0.3 mm was obtained.

Thereafter, the obtained thermal conductive sheet was put into a dryer and then, was heated at 150° C. for 120 minutes, so that the thermal conductive sheet was thermally cured.

In this way, a thermal conductive sheet in a C-stage state was obtained.

### Examples 7 to 9

In conformity with the mixing formulation of Table 2, boron nitride particles, an epoxy resin composition, an additive, and a solvent were blended to be stirred, so that a varnish was prepared.

Next, the varnish was applied to a substrate with an applicator with a gap described in Table 2 to be then allowed to stand at room temperature (at 23° C.) for one night. Thus, methyl ethyl ketone (the solvent) was allowed to volatilize, so that a sheet having a thickness of 200 μm was fabricated.

Thereafter, the obtained sheet was cut so as to be divided into a plurality of pieces when projected in the thickness direction of the sheet, so that divided sheets were obtained (ref: FIG. 2(b)). Subsequently, the divided sheets were laminated in the thickness direction, so that a laminated sheet was obtained (ref: FIG. 2(c)).

Subsequently, the obtained laminated sheet was hot pressed under the same conditions as those described above with the same vacuum hot press machine as that described above (ref: FIG. 2(a)).

Next, a series of the above-described operations of cutting, laminating, and hot pressing (ref: FIG. 2) were repeated four times, so that a thermal conductive sheet in a B-stage state and having a thickness of 400 to 500 μm was obtained.

Thereafter, the obtained thermal conductive sheet was put into a dryer and then, was heated at 150° C. for 120 minutes, so that the thermal conductive sheet was thermally cured.

In this way, a thermal conductive sheet in a C-stage state was obtained.

### (Evaluation)

[Evaluation at Time of Forming of Sheet]

(1) Formability

The formability at the time of forming the thermal conductive sheet in a B-stage state was evaluated by the following criteria.

### <Criteria>

Good: The thermal conductive sheet was capable of being formed into a sheet shape.

Bad: The thermal conductive sheet was not capable of being formed into a sheet shape or the sheet shape was not capable of being retained because of fragility.

[Evaluation of Thermal Conductive Sheet before Thermal Curing]

(2) Thermal Conductivity

The thermal conductivity of the thermal conductive sheet in a B-stage state was measured.

That is, the thermal conductivity in the plane direction (PD) was measured by a pulse heating method using a xenonflash analyzer “LFA-447” (manufactured by Erich NETZSCH GmbH & Co. Holding KG). The thermal conductivity in the thickness direction (TD) was measured by a TWA method using “ai-Phase mobile” (manufactured by ai-Phase Co., Ltd.).

The results are shown in Tables 1 and 2.

(3) Tensile Test

The thermal conductive sheet in a B-stage state was cut into a strip form having a size of 1×4 cm and the obtained strip form was set in a tensile testing machine to measure the tensile elasticity, the maximum tensile strength, and the maximum elongation at the time of stretching the strip form in the longitudinal direction thereof at a rate of 1 mm/min.

The results are shown in Tables 1 and 2.

(4) Bend Resistance (Flexibility)

A bend test in conformity with JIS K 5600-5-1 bend resistance (a cylindrical mandrel method) was performed for the thermal conductive sheet in a B-stage state.

To be specific, the bend resistance (flexibility) of the thermal conductive sheets was evaluated under the following test conditions.

Test Conditions

Test Device: Type I

Mandrel: a diameter of 10 mm

Then, the thermal conductive sheets in a B-stage state were bent to a bending angle of more than 0 degree and 180 degrees or less and were evaluated based on the angle by which a fracture (a damage) was caused in the thermal conductive sheet as follows.

The results are shown in Tables 1 and 2.

Excellent: A fracture was not caused even when bent to 180 degrees.

Good: A fracture was caused when bent to 90 degrees or more and below 180 degrees.

Poor: A fracture was caused when bent to 10 degrees or more and below 90 degrees.

Bad: A fracture was caused when bent to more than 0 degree and below 10 degrees.

(5) Porosity (P)

The porosity (P1) of the thermal conductive sheet in a B-stage state was measured by the following measurement method.

The measurement method of porosity: first, the thermal conductive sheet was cut along the thickness direction with a cross section polisher (CP); the cross section thus appeared was observed with a scanning electron microscope (SEM) at a magnification of 200 to obtain an image; then, the obtained image was binarized based on the pore portion and the non-pore portion; and next, the area ratio of the pore portion with respect to the total area of the cross section of the thermal conductive sheet was calculated.

The results are shown in Tables 1 and 2.

(6) Conformability to Irregularities (3-Point Bending Test)

A 3-point bending test in conformity with JIS K7171 (in 2008) was performed for the thermal conductive sheet in a B-stage state under the following test conditions, so that the conformability to irregularities was evaluated in accordance with the following evaluation criteria. The results are shown in Tables 1 and 2.

Test Conditions

Test Piece: a size of 20 mm×15 mm

Distance between supporting points: 5 mm

Test rate: 20 mm/min (indenter depressing rate)

Bending angle: 120 degrees

(Evaluation Criteria)

Excellent: A fracture was not observed.

Good: Almost no fracture was observed.

Bad: A fracture was clearly observed.

(7) Initial Adhesion Test with Respect to Stainless Steel Substrate

An initial adhesion test of the thermal conductive sheet in a B-stage state with respect to a stainless steel substrate (made of SUS 304) was performed.

That is, the thermal conductive sheet was temporarily fixed to a stainless steel substrate (made of SUS 304) along the horizontal direction using a sponge roll made of a silicone resin by thermocompression bonding at 80° C. to be then allowed to stand for 10 minutes. Thereafter, the stainless steel substrate was reversed upside-down.

Thereafter, the thermal conductive sheet was evaluated in accordance with the following criteria. The results are shown in Tables 1 and 2.

<Criteria>

Good: It was confirmed that the thermal conductive sheet did not fall off from the stainless steel substrate.

Bad: It was confirmed that the thermal conductive sheet fell off from the stainless steel substrate.

[Evaluation of Thermal Conductive Sheet after Thermal Curing]

(8) Glass Transition Temperature

The glass transition temperature of the thermal conductive sheet in a C-stage state was measured.

That is, the thermal conductive sheet was measured with a temperature rising rate of 5° C./min and a frequency of 1 Hz using a dynamic viscoelasticity measuring apparatus (model number: TMASS 6100, manufactured by Seiko Instruments Inc.).

The glass transition temperature was obtained from the obtained data as a peak value of tan δ.

The results are shown in Tables 1 and 2.

(9) 5% Mass Loss Temperature

The 5% mass loss temperature of the thermal conductive sheet in a C-stage state was measured by thermogravimetric analysis (a temperature rising rate of 10° C./min, under a nitrogen atmosphere) using a thermogravimetric analysis apparatus in conformity with JIS K 7120.

The results are shown in Tables 1 and 2.

(10) Heat Resistance

The thermal conductive sheet in a C-stage state was put into a dryer at 150° C. for 1000 hours and the heat resistance of the obtained thermal conductive sheet was evaluated in accordance with the following criteria.

<Criteria>

Good: It was confirmed that there was no change in the thermal conductive sheet.

Bad: It was confirmed that there was a crack or a change of color in the thermal conductive sheet.

The results are shown in Tables 1 and 2.

(11) Orientation Angle (α) of Boron Nitride Particles

The thermal conductive sheet in a C-stage state was cut along the thickness direction with a cross section polisher (CP); the cross section thus appeared was photographed with a scanning electron microscope (SEM) at a magnification of 100 to 2000; a tilt angle (α) between the longitudinal direction (LD) of the boron nitride particles and the plane direction (PD) of the thermal conductive sheet was obtained from the obtained SEM photograph; and the orientation angle (α) of the boron nitride particles was calculated as the average value.

The results are shown in Tables 1 and 2.

TABLE 1

| Examples | | | | | Ex. 1 | Ex. 2 | Ex. 3 | Ex. 4 | Ex. 5 |
|---|---|---|---|---|---|---|---|---|---|
| Mixing | Boron Nitride Particles g | | Plate-Like | PT-110 | 8.66 (60) | 13.47 (70) | 8.68 (60) | 8.68 (60) | 8.68 (60) |
| Formulation | [volume %] | | Shape | | | | | | |
| of Thermal | Epoxy Resin | Epoxy Resin | Crystalline | YSLV-80XY | 1.175 | 1.175 | 1.55 | 1.562 | 1.562 |
| Conductive | Composition | | Bisphenol | | | | | | |
| Composition | | | Epoxy Resin | | | | | | |
| | | | High Molecular | JER 1002 | 1.175 | 1.175 | — | — | — |
| | | | Weight Epoxy | JER 4010P | — | — | 0.517 | — | — |
| | | | Resin | JER 1256 | — | — | — | 0.521 | — |
| | | | | YP-70 | — | — | — | — | 0.521 |
| | | Curing Agent | Phenol-Aralkyl | MEH-7800-S | 0.39 | 0.39 | 0.56 | 0.56 | 0.56 |
| | | | Resin | MEH-7800-SS | 0.26 | 0.26 | 0.37 | 0.37 | 0.37 |
| | | Curing | Imidazole | 2P4MHZ-PW | 0.012 | 0.012 | 0.021 | 0.021 | 0.021 |
| | | Accelerator | Compound | | | | | | |

| | | | | | | | |
|---|---|---|---|---|---|---|---|
| Additive | Dispersant | DISPERBYK-2095 | — | — | — | — | — |
| | Thixotropic Agent | Lucentite STN | — | — | — | — | — |

| | | | | | | |
|---|---|---|---|---|---|---|
| Solvent | Methyl Ethyl | 3 | 3 | 3 | 3 | 3 |
| | Ketone | | | | | |

| Production | Treatment | Hot Pressing | Temperature (° C.) | 80 | 80 | 80 | 80 | 80 |
|---|---|---|---|---|---|---|---|---|
| Conditions | of Thermal | | Load (MPa)/(tons) | 20/5 | 20/5 | 20/5 | 20/5 | 20/5 |
| | Conductive | | Thickness after Pressing (μm) | 300 | 300 | 300 | 300 | 300 |
| | Composition | Application as | Gap of Applicator (μm) | — | | | | |
| | | Varnish | Drying Conditions | | | | | |
| | | | Thickness of Sheet (μm) | | | | | |
| | Treatment of | Hot Pressing | Temperature (° C.) | 80 | 80 | 80 | 80 | 80 |
| | Laminated | | Number of Time of Hot Pressing of | 5 | 5 | 5 | 5 | 5 |
| | Sheet | | Laminated Sheet (times) | | | | | |
| | | | Load (MPa)/(tons) | 20/5 | 20/5 | 20/5 | 20/5 | 20/5 |
| | | | Thickness after Pressing (μm) | 200 | 200 | 200 | 200 | 200 |
| Evaluation | Formability of Sheet | | | Good | Good | Good | Good | Good |
| of Thermal | Before Curing | Thermal | Plane Direction (PD) | 8.6 | 26.4 | 16 | 15.7 | 16.1 |
| Conductive | (B-Stage | Conductivity | Thickness Direction (TD) | 0.6 | 3.4 | 1.8 | 1.5 | 1.6 |
| Sheet | State) | (W/m · K) | | | | | | |
| | | Tensile Test | Tensile Elasticity (GPa) | 0.28 | 0.23 | 0.2 | 0.25 | 0.23 |
| | | | Maximum Tensile Strength (MPa) | 8.7 | 4.3 | 8 | 9.4 | 7.6 |
| | | | Maximum Elongation (%) | 7.7 | 5.5 | 11.5 | 11.9 | 12.6 |

| Flexibility/Bend Test JIS K 5600-5-1 | | Excellent | Excellent | Excellent | Excellent | Excellent |
|---|---|---|---|---|---|---|
| Porosity (volume %) | | 15 | 12 | 14 | 12 | 11 |
| Conformability to Irregularities/3-Point Bending | | Excellent | Good | Excellent | Excellent | Excellent |
| Test JIS K 7171 (in 2008) | | | | | | |
| Initial | vs. Stainless Steel Substrate | Good | Good | Good | Good | Good |
| Adhesion | | | | | | |
| Test | | | | | | |

| | | | | | | |
|---|---|---|---|---|---|---|
| After Curing | Glass Transition Temperature (° C.) | 135 | 135 | 108 | 116 | 110 |
| (C-stage | 5% Mass Loss Temperature (° C.) JIS J 7120 | 347 | 365 | 353 | 355 | 350 |
| State) | Heat Resistance (150° C., 1000 hours) | Good | Good | Good | Good | Good |
| Boron Nitride | Orientation Angle (α) (degrees) | 16 | 13 | 15 | 15 | 14 |
| Particles | | | | | | |

TABLE 2

| Examples | | | | | Ex. 6 | Ex. 7 | Ex. 8 | Ex. 9 |
|---|---|---|---|---|---|---|---|---|
| Mixing | Boron Nitride Particles g | | Plate-Like | PT-110 | 8.66 (60) | 44.72 (70) | 44.72 (70) | 44.72 (70) |
| Formulation | [volume %] | | Shape | | | | | |
| of Thermal | Epoxy Resin | Epoxy Resin | Crystalline | YSLV-80XY | 1.175 | 3.862 | 4.164 | 4.711 |
| Conductive | Composition | | Bisphenol | | | | | |
| Composition | | | Epoxy Resin | | | | | |
| | | | High Molecular | JER 1002 | — | — | — | — |
| | | | Weight Epoxy | JER 4010P | — | — | — | — |
| | | | Resin | JER 1256 | 1.175 | 1.931 | 1.388 | 2.355 |
| | | | | YP-70 | — | — | — | — |
| | | Curing Agent | Phenol-Aralkyl | MEH-7800-S | 0.39 | 2.02 | — | — |
| | | | Resin | MEH-7800-SS | 0.26 | 1.35 | 3.61 | 2.051 |
| | | Curing | Imidazole | 2P4MHZ-PW | 0.012 | 0.174 | 0.167 | 0.212 |
| | | Accelerator | Compound | | | | | |

| | | | | | | |
|---|---|---|---|---|---|---|
| Additive | Dispersant | DISPERBYK-2095 | — | 0.671 | 0.671 | 0.671 |
| | Thixotropic Agent | Lucentite STN | — | 1.2 | 1.2 | 0.6 |

| | | | | | |
|---|---|---|---|---|---|
| Solvent | Methyl Ethyl | 3 | 50 | 50 | 50 |
| | Ketone | | | | |

| Production | Treatment | Hot Pressing | Temperature (° C.) | 80 | — | | |
|---|---|---|---|---|---|---|---|
| Conditions | of Thermal | | Load (MPa)/(tons) | 20/5 | | | |
| | Conductive | | Thickness after Pressing (μm) | 300 | | | |
| | Composition | Application as | Gap of Applicator (μm) | | 800 | 800 | 800 |
| | | Varnish | Drying Conditions | | 70° C. 1 min, | 70° C. 1 min, | 70° C. 1 min, |
| | | | | | 80° C. 15 min | 80° C. 15 min | 80° C. 15 min |
| | | | Thickness of Sheet (μm) | | 400 to 500 | 400 to 500 | 400 to 500 |
| | Treatment of | Hot Pressing | Temperature (° C.) | 80 | 80 | 80 | 80 |
| | Laminated | | Number of Time of Hot Pressing of | 5 | 5 | 5 | 5 |
| | Sheet | | Laminated Sheet (times) | | | | |
| | | | Load (MPa)/(tons) | 20/5 | 9.8/10 | 9.8/10 | 9.8/10 |
| | | | Thickness after Pressing (μm) | 200 | 200 | 200 | 200 |
| Evaluation | Formability of Sheet | | | Good | Good | Good | Good |
| of Thermal | Before Curing | Thermal | Plane Direction (PD) | 18.9 | 27.5 | 27 | 22 |
| Conductive | (B-Stage | Conductivity | Thickness Direction (TD) | 2 | 2.5 | 2.8 | 2.5 |
| Sheet | State) | (W/m · K) | | | | | |
| | | Tensile Test | Tensile Elasticity (GPa) | 3.16 | 1.34 | 0.82 | 1.13 |
| | | | Maximum Tensile Strength (MPa) | 19.7 | 7.8 | 10.6 | 7.0 |
| | | | Maximum Elongation (%) | 1.1 | 0.6 | 1.2 | 0.8 |

| Flexibility/Bend Test JIS K 5600-5-1 | | Excellent | Excellent | Excellent | Excellent |
|---|---|---|---|---|---|
| Porosity (volume %) | | 8 | 8 | 11 | 13 |
| Conformability to Irregularities/3-Point Bending | | Good | Good | Excellent | Excellent |
| Test JIS K 7171 (in 2008) | | | | | |
| Initial | vs. Stainless Steel Substrate | Good | Good | Good | Good |
| Adhesion | | | | | |
| Test | | | | | |

| | | | | | |
|---|---|---|---|---|---|
| After Curing | Glass Transition Temperature (° C.) | 105 | 125 | 130 | 123 |
| (C-stage | 5% Mass Loss Temperature (° C.) JIS J 7120 | 355 | 360 | 368 | 362 |
| State) | Heat Resistance (150° C., 1000 hours) | Good | Good | Good | Good |
| Boron Nitride | Orientation Angle (α) (degrees) | 16 | 12 | 13 | 12 |
| Particles | | | | | |

In Tables 1 and 2, values for the components are in grams unless otherwise specified.

In the rows of “Boron Nitride Particles” in Tables 1 and 2, the values on the top represent the blended weight (g) of the boron nitride particles and the values in parentheses at the bottom represent the volume percentage (volume %) of the boron nitride particles with respect to the thermal conductive sheet.

For the abbreviations of the components in Tables 1 and 2, details are given in the following.

PT-110: trade name, plate-like boron nitride particles, an average particle size (a light scattering method) of 45 μm, manufactured by Momentive Performance Materials Inc.

YSLV-80XY: trade name, a crystalline bisphenol F epoxy resin, an epoxy equivalent of 180 to 210 g/eq., solid at normal temperature, the melting point of 75 to 85° C., manufactured by NIPPON STEEL CHEMICAL CO., LTD.

JER 1002: trade name, a high molecular weight bisphenol A epoxy resin, a weight average molecular weight of 1200, an epoxy equivalent of 600 to 700 g/eq., solid at normal temperature, a softening point of 78° C., manufactured by Mitsubishi Chemical Corporation

JER 4010P: trade name, a high molecular weight bisphenol F epoxy resin, a weight average molecular weight of 42000, an epoxy equivalent of 4400 g/eq., solid at normal temperature, a softening point of 135° C., manufactured by Mitsubishi Chemical Corporation

JER 1256: trade name, a high molecular weight bisphenol A epoxy resin, a weight average molecular weight of 56000, an epoxy equivalent of 7500 to 8500 g/eq., solid at normal temperature, a softening point of 85° C., manufactured by Mitsubishi Chemical Corporation

YP-70: trade name, a high molecular weight bisphenol epoxy resin, a weight average molecular weight of 60000 to 80000, solid at normal temperature, a softening point of 70° C., manufactured by NIPPON STEEL CHEMICAL CO., LTD.

MEH-7800-S: trade name, a phenol-aralkyl resin, a curing agent, a hydroxyl group equivalent of 175 g/eq., solid at normal temperature, a softening point of 73 to 78° C., a melting viscosity (at 150° C.) of 0.23 Pa·s, manufactured by MEIWA PLASTIC INDUSTRIES, LTD.

MEH-7800-SS: trade name, a phenol-aralkyl resin, a curing agent, a hydroxyl group equivalent of 175 g/eq., solid at normal temperature, a softening point of 63 to 67° C., a melting viscosity (at 150° C.) of 0.10 Pa·s, manufactured by MEIWA PLASTIC INDUSTRIES, LTD.

2P4MHZ-PW: trade name, Curezol 2P4MHZ-PW, 2-phenyl-4-methyl-5-hydroxymethyl imidazole, an imidazole compound, manufactured by Shikoku Chemicals Corporation

DISPERBYK-2095: trade name, a mixture of polyaminoamide salt and polyester, a dispersant, manufactured by BYK Japan K.K.

Lucentite STN: trade name, smectite to which a surface treatment is applied with a cationic dispersant, manufactured by Co-op Chemical Co., Ltd.

While the illustrative embodiments of the present invention are provided in the above description, such is for illustrative purpose only and it is not to be construed as limiting the scope of the present invention. Modification and variation of the present invention that will be obvious to those skilled in the art is to be covered by the following claims.

What is claimed is:

1. A thermal conductive sheet comprising:
boron nitride particles, an epoxy resin, and a curing agent, wherein
the epoxy resin contains a crystalline bisphenol epoxy resin and
the curing agent contains a phenol resin having a partial structure represented by the following formula (1).

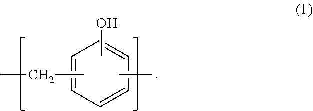

2. The thermal conductive sheet according to claim 1, wherein
the crystalline bisphenol resin is represented by the following formula (2).

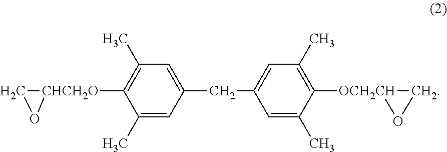

3. The thermal conductive sheet according to claim 1, wherein
the epoxy resin further contains a high molecular weight epoxy resin having a weight average molecular weight of 1000 or more.

4. The thermal conductive sheet according to claim 1, wherein
the phenol resin contains a phenol-aralkyl resin.

5. The thermal conductive sheet according to claim 1, wherein
the boron nitride particles are formed into a plate-like shape and
the thermal conductivity in a direction perpendicular to the thickness direction of the thermal conductive sheet is 4 W/m·K or more.
